(19) United States
(12) Patent Application Publication
(10) Pub. No.: US 2020/0087601 A1
(43) Pub. Date: Mar. 19, 2020

(54) METHOD OF MANAGING CONSUMPTION OF SOAP

(71) Applicants: Ramzi Khalil Maalouf, Chevy Chase, MD (US); Masumi Aoki, Kyoto (JP); Jinrong Yang, Shanghai (CN)

(72) Inventors: Ramzi Khalil Maalouf, Chevy Chase, MD (US); Masumi Aoki, Kyoto (JP); Jinrong Yang, Shanghai (CN)

(21) Appl. No.: 16/191,610

(22) Filed: Nov. 15, 2018

Related U.S. Application Data
(60) Provisional application No. 62/733,080, filed on Sep. 18, 2018.

(51) Int. Cl. C11D 17/00; C11D 13/00

(52) U.S. Cl. CPC C11D 17/0047; C11D 13/00; C11D 17/0039

(57) ABSTRACT

A method for managing hard soap bar consumption is disclosed. In one embodiment, a first portion of the hard soap bar surface remains exposed to allow that portion of the soap bar surface to interface with the water as a traditional soap bar, and a second portion of the soap bar surface is configured to receive a hydro-phobic and oleo-phobic coated film that prevents the soap bar material below the film from interacting with the water. The oleo-phobic coating also prevents oil particles (and their associated germs) from attaching to the surface of the membrane. In this embodiment, only the first portion of the soap bar material is interfacing (being used) while the soap bar material below the second portion is not interfacing and thus remains hard and intact. As the soap bar material in the first portion is being used, the membrane along the planar outer perimeter edge is also gradually fading.

### PRIORITY CLAIM

This application claims priority to U.S. Application Ser. No. 62/733,080, entitled “METHOD FOR MANAGING CONSUMPTION OF SOAP”, filed Sep. 18, 2018, which is incorporated by reference as if fully set forth herein.

### BACKGROUND

### Field

The present invention relates to the field of soap and methods of making and using soap. More specifically, embodiments herein relate to methods of managing consumption of soap.

### Description of the Related Art

The traditional hard soap bar is still the primary method of personal cleaning used throughout the world for over two thousand years. Since that time, hard soap bars have been widely used in the same manner, by hand-gripping the hard soap mixed with water, wetting it, and applying one of its surfaces to the product being cleaned. However, this traditional method also depletes the soap that is being lathered from the soap's other surfaces which are being uselessly washed away without interfacing with the product, thus wasting valuable soap resources.

### SUMMARY

Various embodiments of soap, methods of making and using soap, and methods of managing consumption of soap are described. In one embodiment, a method of managing consumption of soap during cleaning includes keeping a first portion of the soap bar surface exposed to normally interact with the water, and coating a second portion of the soap bar surface with a waterproof membrane to prevent interaction with the water. The soap material beneath the second portion thus remains solid and intact, saving valuable soap resources that would have otherwise been wasted when using a traditional soap bar without a waterproofing film.

In an embodiment, a hard soap bar includes a hydro-oleo phobic coating film. The film may, in certain embodiments, be in the form of a membrane. The film is applied over certain portions of the bar's surface to prevent contact with water and preserve the soap material beneath the film.

In some embodiments, an oleo-phobic coating prevents oil particles (and their associated germs) from attaching to the surface of the membrane, and potentially, to the soap molecules.

In an embodiment, a cleaning bar includes a body comprising a cleaning material and a shell partially covering the body. The shell includes a film that at least partially protects a surface of the body from water or oil. At least a portion of the surface of the body is exposed to allow a user to clean with the exposed surface.

In an embodiment, a method of making a cleaning bar includes covering a portion of a bar of soap with a protective layer of material; and leaving a portion of the bar of soap uncovered.

In an embodiment, a method of cleaning includes covering a portion of a bar of soap with a hydrophobic material; and using an uncovered portion of the bar to clean one or more items.

In one embodiment, a first portion (1 side, for example) of the hard soap bar surface remains exposed to allow that portion of the soap bar surface to interface with the water as a traditional soap bar, and a second portion (1 or all other remaining sides, for example) of the soap bar surface is configured to receive a hydro-phobic and oleo-phobic coated film (which may be referred to herein as a “membrane”) that prevents the soap bar material below the membrane from interacting with the water. The oleo-phobic coating also prevents oil particles (and their associated germs) from attaching to the surface of the membrane. In this embodiment, only the first portion of the soap bar material is interfacing (being used) while the soap bar material below the second portion is not interfacing and thus remains hard and intact, conserving valuable soap material that would have otherwise been wasted in a traditional soap bar where the entire soap bar is exposed to interfacing with water. As the soap bar material in the first portion is being used (dissolved), the membrane along the planar outer perimeter edge is also gradually fading.

### BRIEF DESCRIPTION OF THE DRAWINGS

FIG. 1 illustrates one embodiment of a hard soap bar including a film applied on certain portions of the bar.

FIG. 2 illustrates a film applied to selected portions of top surfaces of a cylindrical bar.

FIG. 3 illustrates a film applied to a surface of a cleaning bar in a crossing stripes pattern.

FIG. 4A illustrates one embodiment of a cleaning bar having a film on side surfaces prior to use.

FIG. 4B illustrates the cleaning bar shown in FIG. 4A after it has been partially consumed.

FIG. 5 illustrates one embodiment of a kit for applying a film to a bar of soap.

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF ILLUSTRATIVE EMBODIMENTS

Various embodiments of soap, methods of making and using soap, and methods of managing consumption of soap are described.

In one embodiment, a first portion (1 side, for example) of the hard soap bar surface remains exposed to allow that portion of the soap bar surface to interface with the water as a traditional soap bar, and a second portion (1 or all other remaining sides, for example) of the soap bar surface is configured to receive a hydro-phobic and oleo-phobic coated film (which may be referred to herein as “membrane”). The membrane may inhibit or prevent the soap bar material below the membrane from interacting with the water. The oleo-phobic coating may prevent oil particles (and their associated germs) from attaching to the surface of the membrane. In this embodiment, only the first portion of the soap bar material is interfacing (being used) while the soap bar material below the second portion is not interfacing and thus remains hard and intact, conserving valuable soap material that would have otherwise been wasted in a traditional soap bar where the entire soap bar is exposed to interfacing with water. As the soap bar material in the first portion is being used (dissolved), the membrane along the planar outer perimeter edge also gradually fades.

In an embodiment, a cleaning bar includes a body including a cleaning material and a shell partially covering the body. The shell includes a film that at least partially protects a surface of the body from water and/or oil. At least a portion of the surface of the body is exposed to allow a user to clean with the exposed surface.

In an embodiment, a method of making a cleaning bar includes covering a portion of a bar of soap with a protective layer of material (which may be hydrophobic, oleo-phobic, or both), and leaving a portion of the bar of soap uncovered.

In an embodiment, a method of cleaning includes covering a portion of a bar of soap with a protective layer of material (which may be hydrophobic, oleo-phobic, or both); and using an uncovered portion of the bar to clean one or more items.

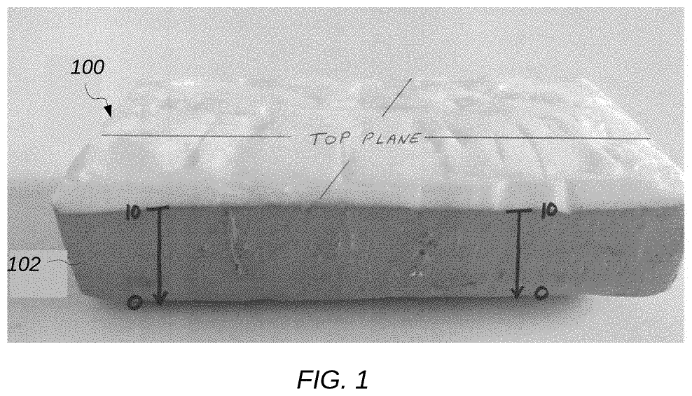

FIG. 1 illustrates one embodiment of a hard soap bar including a membrane applied on certain portions of the bar. Bar 100 may be used to clean a body part, garment, utensil, or other item. Bar 100 may include a body (e.g., bar of soap) and hydro-oleo phobic film 102. Hydro-oleo phobic film 102 may be applied to bottom, front, back, left, right surface of the body of a bar of soap from 0 to 10 level near the top of FIG. 1. Hydro-oleo phobic film 102 may be water-proof and oil-proof.

The top plane of the body may remain exposed and interact with the product being cleaned. From bottom up on the front, back and sides planes, up to 10, water and oil do not penetrate the surface of the membrane to reach the protected surface of the bar of soap.

During cleaning, bar 100 may be held from the bottom of the bar. As bar 100 is used to clean the product, hydro-oleo phobic film 102 protects the surfaces of body other than the top plane. Film 102 may, in certain embodiments, be in the form of a membrane. As the top plane material is being depleted, so is the adjoining outside perimeter of film 102. Thus, film 102 may naturally and progressively fade (from 10, 9, 8), down to 0 shown in FIG. 1, when the entire soap bar is consumed. In various embodiments, the progressive fading of membrane 102 as the soap material of the body is consumed may occur by mechanisms including, wearing, peeling, rubbing, abrasion, dissolving, or combinations thereof.

In various embodiments, a film may cover various portions of a solid body of cleaning material (e.g., a bar of soap). Soap bars or other cleaning bars with protective shells, films, or membrane may come in any of various shapes or sizes. A protective layer may be applied to a full surface, a part of a surface, or to one or more full surfaces, or one or more parts of surfaces. In certain embodiments, a protective layer is applied to random portions of the surface of a body of cleaning material (e.g., a bar of soap).

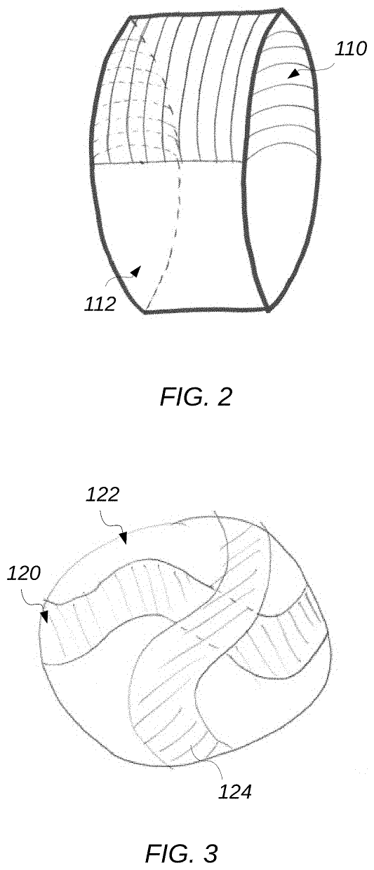

FIG. 2 illustrates a film 110 (e.g., membrane) applied to a cylindrical bar 112. Film 110 may be hydro-oleophobic. Film 110 is applied to a portion of the top of bar 112. Another portion of the bar (in this case, a bottom portion) remains uncoated.

FIG. 3 illustrates a film 120 (e.g., a membrane) applied to bar 122 in a crossed striped pattern. Film 120 may be hydro-oleophobic. Film 120 is applied in stripes 124 across the surface of bar 122. Other non-continuous arrangements of film elements may include a grid, a honeycomb pattern, parallel stripes, an array of dots, or a checkboard pattern.

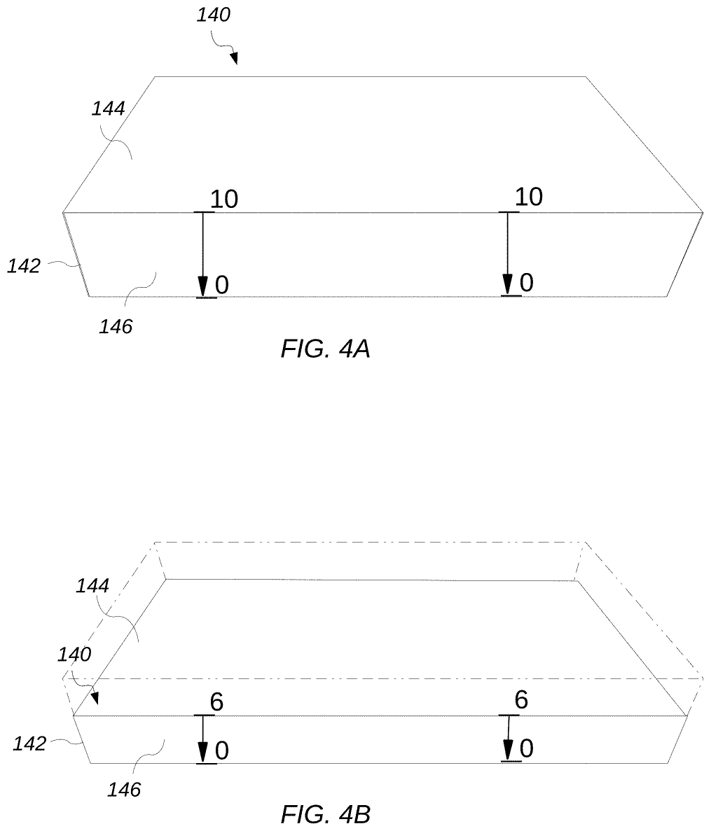

FIG. 4A illustrates one embodiment of a cleaning bar having a film on side surfaces prior to use. Bar 140 includes sides 142 (front, back, left, right) and top surface 144. Film 146 may be applied to sides 142 and the bottom surface of bar 140. Film 146 may be intentionally not applied to top surface 144. Before consumption, bar 140 is at its original thickness, with top surface 144 indicated in FIG. 4A corresponding to level 10.

FIG. 4B illustrates the cleaning bar shown in FIG. 4A after it has been partially consumed. As compared with the bar shown in FIG. 4A, bar 140 has been consumed such that top surface 144 is reduced to level 6. During consumption, film 146 may progressively fade from top to bottom on the sides 142 of bar 140. Film 146 may remain intact on the bottom surface of bar 140.

In FIG. 4A, consumption of bar 140 in even across top surface 144, such that top surface 144 may remain substantially planar as bar 140 is consumed. Nevertheless, consumption of a cleaning bar in certain embodiments, be non-uniform across the consumed surface. In some embodiments, film thickness may be varied from one surface to another to achieve a different rate of exposure for different surfaces of the cleaning bar. For example, the bottom of the cleaning bar may have a protective film that is thicker than that of the sides. In certain embodiments, film thickness may be graduated. For example, the film on the side surface of a cleaning bar may be applied such that is progressively thicker from top to the bottom of the bar. In certain embodiments, different portion of a surface may have different a different film thickness. For example, top surface 144 may be thinner near the center of the top surface than it is near the edges.

In some embodiments, a protective layer is included on the bottom of a cleaning bar. In certain embodiments, the protective layer may be a sufficient thickness and/or form a sufficient water barrier to reduce or eliminate contact of the body of the cleaning bar with water resting (e.g. pooled) on the surface on which the bar is placed.

A shell or film may be applied to a block of cleaning material (e.g., a bar of soap) by any suitable method of application. Examples of methods for application include spraying, dipping, painting, or applying sheets of protective film (e.g., held by pressure-sensitive adhesive).

In some embodiments, a protective shell or film of a cleaning bar is applied during production. The cleaning bar may be distributed (e.g., through retail stores) with protective shell. In other embodiments, a protective film may be applied after the original production of the cleaning production, and even after distribution the user. For example, a user may apply a protective coating (e.g., hydro/oleo phobic coating) to an ordinary, uncoated bar of soap after acquiring the ordinary bar of soap. In certain embodiments, the protective film is applied using container of protective material applied by the user while the original cleaning bar is held in a fixture. In one embodiment, a kit for making a cleaning bar includes a holder configured to hold a bar of soap; and a container including a material configured to cover a portion of the bar of soap.

In an embodiment, a kit for making a cleaning bar includes a holder configured to hold a bar of soap; and a container comprising a material configured to cover a portion of the bar of soap. The container may include a spray container. The holder may at least partially cover a surface of the bar of soap to inhibit covering of the surface by the material.

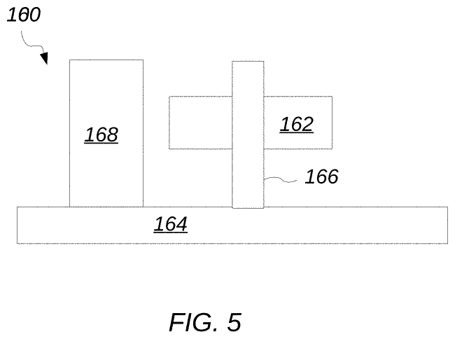

FIG. 5 illustrates one embodiment of a kit for applying a film to a bar of soap. Kit 160 includes may be used to apply a hydro/oleo phobic coating to soap bar 162. Kit 160 includes base 164, holder 166, and container 168. Container 168 may include material to be applied to soap bar 162 to form a film on portions of soap bar 162.

Although, in various embodiments, the protective layer for a cleaning bar is described as a membrane, the protective layer may in various embodiments be a film, coating, sheet, or other suitable element.

Although, in various embodiments, the membrane or film of a cleaning bar has been described as hydro-phobic and oleo-phobic, the membrane, film, or shell of a cleaning bar may in certain embodiments be only hydro-phobic, only oleo phobic, or neither hydro-phobic nor oleo-phobic.

Although, in various embodiments, a block of cleaning material to which a protective layer is applied has been described as hard soap, the base cleaning material, may, in certain embodiments, be another form of cleaning material. Although the block of material may be rigid, it may also, in certain embodiments, be flexible, bendable, or spongy.

Although, in various embodiments, the exposed surface of the cleaning bar has been shown as planar and on the top of the bar, the exposed surface or surfaces of a cleaning bar may in various embodiments be non-planar or on surfaces other than the top surface. For example, in one embodiment, the exposed surface of the cleaning bar may be domed, crowned, convex, or ridged. In some embodiments, exposed or unexposed surface of a cleaning bar may have waves, ridges, or other regular or irregular surface variations.

As used herein, a “bar” refers to a block of material or materials. In some cases, a bar includes an exterior shell, film, coating, or membrane. A bar may be any of various shapes, including elongated, prismatic, ovate, oblong, cubic, spherical, ovate, or irregular. A “cleaning bar” refers to any bar that can be used for cleaning. A cleaning bar may be used to clean anyone or anything, including a person, an animal, a vehicle, a building, or any object, or one or more surfaces of an object or structure. In some cases, a bar is or includes a bar of soap.

As used herein, “shell” refers to an exterior layer, covering, coating that at least partially encloses or covers another portion of a thing.

As used herein, “film” refers to any coating, membrane, or layer of material. A film may be a thin layer or coating applied to the exterior of all or a portion another object, such as a bar of soap.

As used herein, an “item” cleaned may be anything, including a person, animal, utensil, tool, building, vehicle, portable object, or fixed object, or a surface thereof.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims. In addition, none of the claims is intended to invoke 35 U.S.C. Section 112(f) unless the exact words “means for” are followed by a gerund.

What is claimed is:

1. A cleaning bar, comprising:
a body comprising a cleaning material; and
a shell partially covering the body, wherein the shell comprises a film configured to at least partially protect a surface of the body from water or oil,
wherein at least a portion of the surface of the body is exposed to allow a user to clean with the exposed surface.

2. The cleaning bar of claim 1, wherein the film comprises a hydrophobic material.

3. The cleaning bar of claim 1, wherein the film comprises an oleo-phobic material.

4. The cleaning bar of claim 1, wherein the film comprises a hydrophobic, oleo-phobic material.

5. The cleaning bar of claim 1, wherein the cleaning material comprises a bar of soap, wherein the shell comprises a film applied to one or more surfaces of the bar of soap.

6. The cleaning bar of claim 1, wherein the exposed portion comprises the top of the body, wherein the covered portions comprise the bottom and sides of the body.

7. The cleaning bar of claim 1, wherein the exposed portion comprises the top of the body, wherein the covered portions comprise the bottom of the body.

8. The cleaning bar of claim 1, wherein the exposed portion comprises the top of the body, wherein the covered portions comprise the bottom of the bar of soap, wherein the covering on the bottom of the body is configured to inhibit exposure of the bottom of the body to water on a surface on which the cleaning bar is placed.

9. The cleaning bar of claim 1, wherein the film is configured to progressively fade as the cleaning bar is used to clean one or more items.

10. A method of making a cleaning bar, comprising:
covering a portion of a bar of soap with a protective layer of material; and
leaving a portion of the bar of soap uncovered.

11. The method of claim 10, wherein the exposed portion comprises the top of the bar of soap, wherein the covered portions comprise the bottom and sides of the bar of soap.

12. The method of claim 10, wherein the exposed portion comprises a portion of the top surface of the bar of soap, wherein a greater portion of the top surface of the bar is progressively exposed during use of the bar of soap to clean one or more items.

13. The method of claim 10, wherein the film comprises a hydrophobic, oleo-phobic material.

14. The method of claim 10, wherein the side layers of the protective film progressively disappear during use of the bar of soap to expose more of the bar of soap so that the bar of soap can be consumed to clean items.

15. A method of cleaning, comprising:
covering a portion of a bar of soap with a hydrophobic or oleo-phobic material; and
using an uncovered portion of the bar to clean one or more items.

16. The method of claim 15, wherein the film comprises a hydro-phobic, oleo-phobic material.

17. The method of claim 15, wherein the film progressively fades to expose surface as the bar of soap is used to clean one or more items.
